(19) United States
(12) Patent Application Publication
(10) Pub. No.: US 2013/0206934 A1
(43) Pub. Date: Aug. 15, 2013

(54) Adjustable Stand

(71) Applicant: LEICA MICROSYSTEMS (SCHWEIZ) AG, (US)

(72) Inventors: Marco Schutz, Rorschach (CH); Roman Frick, Speicher (CH)

(73) Assignee: LEICA MICROSYSTEMS (SCHWEIZ) AG, HEERBRUGG (CH)

(21) Appl. No.: 13/765,160

(22) Filed: Feb. 12, 2013

(30) Foreign Application Priority Data
Feb. 14, 2012 (DE) 10 2012 202 222.8

(51) Int. Cl. G02B 7/00

(52) U.S. Cl. CPC G02B 7/001
USPC 248/123.2

(57) ABSTRACT

The present invention relates to an adjustable stand having a first arm (104) and a second arm (106), the second arm (106) being articulatedly connected to the first arm (104), a first compensation weight (120) having a first mass being provided on the first arm (104), and a second compensation weight (130) having a second mass being provided on the second arm (106), the first and the second compensation weight (120, 130) each being provided with modifiable masses, an increase or decrease in the mass of the first compensation weight (120) being accompanied by a corresponding respective decrease or increase in the mass of the second compensation weight (130).

### CROSS REFERENCE TO RELATED APPLICATIONS

This application claims priority of German patent application number 10 2012 202 222.8 filed Feb. 14, 2012, the entire disclosure of which is incorporated by reference herein.

### FIELD OF THE INVENTION

The present invention relates to an adjustable stand.

### BACKGROUND OF THE INVENTION

For easy handling of heavy medical observation devices such as, for example, surgical microscopes, it is usual to provide adjustable stands on which the observation devices can be secured or mounted. It is usual in this context, in order to ensure sensitive and simple horizontal and vertical movability requiring little effort, to provide compensation weights on the stand that serve to counterbalance the weight of the optical observation device attached to the stand. Because it is moreover typical for different optical observation devices that correspondingly have different weights to be used together with a stand, it must also be possible to adapt the compensation weights to different medical observation devices.

U.S. Pat. No. 6,050,530 proposes for these purposes a displaceability of counterweights on the stand by means of corresponding horizontal and vertical slide mechanisms. These slide mechanisms are perceived as relatively complex; the need to position compensation weights at different positions on the stand and to immobilize (secure) them at those positions is also associated with a relatively high level of complexity. The system presented in this existing art also exhibits only a relatively short travel distance for the respective compensation weights, so that optical devices to be mounted can be mounted only within a specific weight range. If a specific additional weight caused by the optical device is exceeded, the compensation weight must be supplemented with an additional weight. Additional compensation weights of this kind must be supported in device-independent fashion, which results in increased logistical complexity.

### SUMMARY OF THE INVENTION

The object of the present invention is therefore the provision of an adjustable stand that is usable in simple and reliable fashion for a plurality of medical observation devices of different weights.

This object is achieved by an adjustable stand described herein.

The present invention provides an adjustable stand that can be handled in simple fashion, with which an adaptation of compensation weights or compensation masses to different attached devices is possible in simple and reliable fashion.

According to a preferred embodiment, the first compensation weight is provided as a fluid reservoir having a fluid filling, and the second compensation weight likewise as a fluid reservoir having a fluid filling, the fluid reservoirs communicating with one another via a fluid conduit in order to make available the modifiability of the masses of the compensation weights. This makes it possible, in simple fashion, to configure the masses of the two compensation weights modifiably, such that an increase in, for example, the mass of the first compensation weight brings about a corresponding decrease in the mass of the second compensation weight, and vice versa. This system can be implemented, for example, by providing corresponding pumps and valves at suitable points in the fluid conduit and/or the fluid reservoirs. It is conceivable to provide, for example, at a point in the fluid conduit between the first fluid reservoir and the second fluid reservoir, a pump having a corresponding number of one-way and two-way valves that are controllable by means of a control device in order to establish desired fluid fillings of the respective fluid reservoirs.

According to a further preferred embodiment of the invention, the first compensation weight and the second compensation weight are provided by means of a chain windable and unwindable at its two ends, a winding or unwinding of the chain at its first end bringing about an increase or decrease, respectively, in the mass of the first compensation weight, and a corresponding decrease or increase, respectively, in the mass of the second compensation weight. According to this embodiment, the first compensation weight is thus constituted substantially by the more or less wound-up first end of the chain, and the second compensation weight by the correspondingly wound-up second end of the chain. The term “chain” is to be understood here to comprise any chain or cable-shaped apparatuses, for example cables, bounds, ribbons, or belts. For example, it is possible to use metallically weighted chains, ribbons, cables, or belts. This configuration allows a mechanically very robust and simple implementation of the invention. Winding and unwinding of the chain is possible in simple fashion, for example, by means of corresponding electric drive systems.

It is preferred that the first arm and/or the second arm of the adjustable stand be embodied as parallel-member links. Parallel-member links of this kind, also referred to as articulated parallelograms, prove to be particularly easily and reliably operable in practice.

It is further preferred that the first arm of the stand be pivotably supported on a carrier element. This carrier element can be, for example, a carrier column that is usefully secured on a floor or a on table, or also a linkage or mount that can be secured on a ceiling.

A mounting device for securing a medical device is expediently provided on the second arm of the adjustable stand.

The adjustable stand according to the present invention is preferably provided for optical observation devices, in particular surgical microscopes.

Further advantages and embodiments of the invention are evident from the description and the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described below in detail with reference to the drawings.

### BRIEF DESCRIPTION OF THE DRAWINGS

In the drawings:

FIG. 1 is a schematic side view of a preferred embodiment of an adjustable stand according to the present invention.

### DETAILED DESCRIPTION OF THE INVENTION

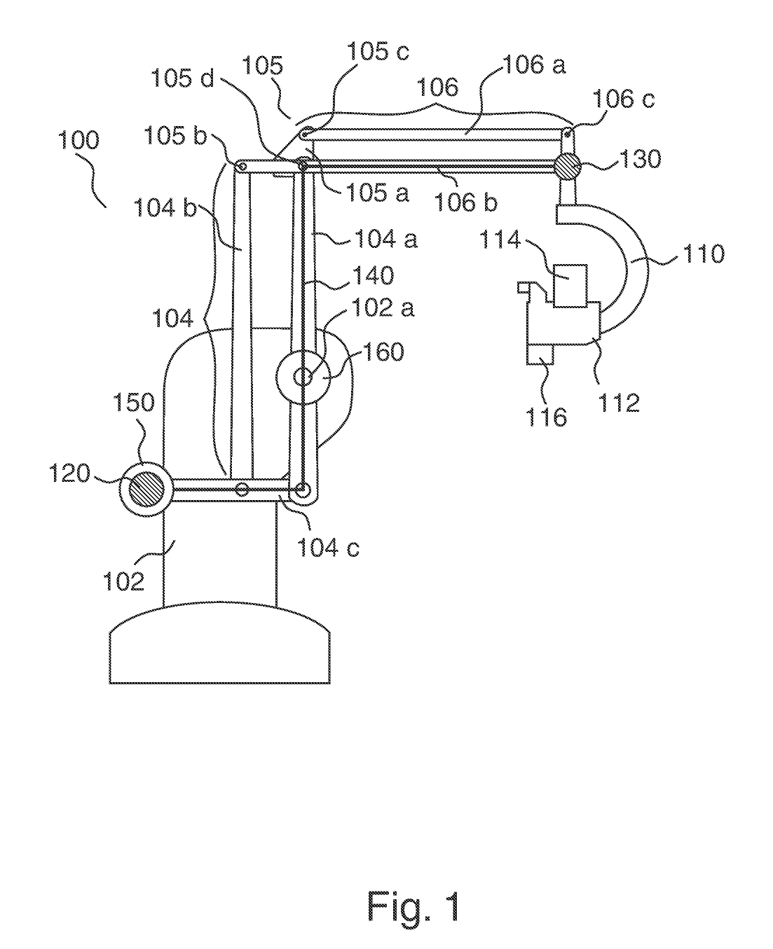

A preferred embodiment of an adjustable stand according to the present invention is designated 100 in its entirety in FIG. 1. The stand comprises as a carrier element a carrier column 102 on which a parallel-member linkage is pivotably supported in order to provide a first arm and a second arm.

The parallel-member linkage comprises a first parallel-member link (first arm) 104 having rods 104a, 104b, as well as a second parallel-member link (second arm) 106 having rods 106a, 106b. Parallel-member linkage 104, 106 is pivotable as a whole around a rotation point 102a (implemented e.g. as a rotation axis) that is provided on carrier column 102. Parallel-member link 106 is furthermore pivotable with respect to parallel-member link 104 by means of a mechanism 105 that comprises an angle element 105a and rotation points or pivot points 105b, 105c, 105d (which can likewise be implemented as rotation axes). Parallel-member link 106 thus serves as an extension arm for parallel-member link 104. A braking or locking device 160, with which the positions of the stand can be defined once established, is expediently provided. This device can be provided, for example, in the vicinity of rotation point 102a. Further rotation points of the respective parallel-member links are evident from the Figure and are not individually labeled.

A medical optical apparatus, in particular a surgical microscope 112, optionally comprising auxiliary apparatuses 114, 116, is mounted at the free or distal end 106c of parallel-member link 106 by means of a mounting apparatus 110.

In order to counterbalance the weight of medical optical apparatus 112 (and optionally of auxiliary apparatuses 114, 116), a first compensation weight 120 is embodied on a horizontal connecting rod 104c of first parallel-member link 104. A further compensation weight 130 is provided at the distal end of second parallel-member link 106. In contrast to the prior art, compensation weights 120, 130 are provided non-slidably on the respective parallel-member links.

First compensation weight 120 and second compensation weight 130 have modifiable masses. These masses are operatively connected to one another in such a way that an increase in, for example, the mass of first compensation weight 120 brings about a corresponding decrease in the mass of compensation weight 130. In the exemplifying embodiment depicted, this is implemented by the fact that first compensation weight 120 and second compensation weight 130 are each provided as a fluid reservoir having fluid present therein. These fluid reservoirs are interconnected by means of a fluid conduit 140. Thanks to the provision of a controllable pump mechanism 150 that can be arranged, for example, at the schematically indicated location 150, i.e. in the immediate vicinity of first compensation weight 120, fluid is transportable between the fluid reservoir of first compensation weight 120 and the fluid reservoir of second compensation weight 130. Depiction of an associated control system and of expediently provided controllable valves, which can be embodied as one-way and/or two-way valves, has been omitted for purposes of clarity.

In a freely selectable initial state, the system as a whole is counterbalanced so that the sum of the torques at rotation point 102a, which depend substantially on compensation weights 120, 130 and on devices 112, 114, 116 attached to mount 110, is identical or equal to zero. The counterbalanced initial state can be selected, for example, for a specific optical device 112 provided as a surgical microscope. In this initial state it is conceivable, for example, to subdivide the distribution of fluid between the fluid container of first compensation weight 120 and the fluid container of second compensation weight 130 at a specific ratio. If, for example, the surgical microscope or one of auxiliary apparatuses 114, 116 is then removed, a torque is produced which can be compensated for on the one hand by a reduction of the mass of first compensation weight 120, or an elevation of the mass of second compensation weight 130. According to the present invention, a simultaneous reduction of the mass of first compensation weight 120 and an elevation of the mass of compensation weight 130 is possible. A coupled action of this kind has the advantage that re-balancing can occur substantially more rapidly than was possible with conventional approaches, and secondly that smaller masses in total need to be displaced.

A corresponding procedure is to be used for the reverse operation. For example, if a further auxiliary apparatus is attached to mount 110, a reduction of the mass of second compensation weight 130, and a corresponding elevation of the mass of compensation weight 120, must be effected.

Expediently, sensors are provided which sense the torques and convey corresponding data to a control device. This control device can then bring about a suitable distribution of fluid between the respective fluid containers.

The invention can also be implemented, for example, by means of a chain that can be wound and unwound at its two ends, the more or less wound-up ends of the chain corresponding to the two compensation weights whose masses are modifiable by corresponding winding or unwinding of the chain. A chain of this kind thus extends between the first and the second compensation weight, and is respectively wound up and un-wound at the locations of said two compensation weights. In the same manner as described above for a fluid-based system, the mass available at the locations of the compensation weights is thus variable by correspondingly winding or unwinding the chain in one direction or the other. When such a chain (or a correspondingly embodied cable, bands, ribbon, or belt) is used, suitable deflection points can be provided, which do not necessarily coincide with the deflection points depicted (schematically) in FIG. 1 for fluid conduit 140.

The invention is not to be limited to the specific embodiments disclosed, and modifications and other embodiments are intended to be included within the scope of the invention.

### PARTS LIST

100 Adjustable stand
102 Carrier column or carrier element
102a Rotation point (rotation axis)
104 Parallel-member link
104a, 104b Rods
104c Connecting rod
105 Mechanism
105a Angle element
105b-d Rotation points (rotation axes)
106 Parallel-member link
106a, 106b Rods
106c Free or distal end
110 Mounting apparatus
112 Medical optical apparatus, in particular surgical microscope
114, 116 Auxiliary apparatuses
120 First compensation weight
130 Second compensation weight
140 Fluid conduit
150 Controllable pump mechanism
160 Braking or locking device

What is claimed is:

1. An adjustable stand, comprising:
a first arm (104) and a second arm (106), the second arm (106) being articulatedly connected to the first arm (104);
a first compensation weight (120) having a first mass on the first arm (104); and
a second compensation weight (130) having a second mass on the second arm (106);
wherein the first mass of the first compensation weight (120) and the second mass of the second compensation weight (130) are modifiable such that an increase or decrease of the first mass of the first compensation weight (120) corresponds to a respective decrease or increase of the second mass of the second compensation weight (130).

2. The stand according to claim 1, wherein the first compensation weight (120) is a fluid reservoir, and the second compensation weight (130) is a fluid reservoir, the fluid reservoir of the first compensation weight being in fluid communication with the fluid reservoir of the second compensation weight via a fluid conduit (140); and
wherein a fluid is configured to flow between the first compensation weight (120) and the second compensation weight (130) via the fluid conduit (140) to produce the increase or decrease of the first mass of the first compensation weight (120) and the respective decrease or increase of the second mass of the second compensation weight (130).

3. The stand according to claim 1, wherein a windable chain extends between the first compensation weight (120) and the second compensation weight (130), the chain being configured to produce the increase or decrease of the first mass of the first compensation weight (120) and the respective decrease or increase of the second mass of the second compensation weight (130).

4. The stand according to claim 1, wherein the first arm (104) is a parallel-member link.

5. The stand according to claim 1, wherein the second arm (106) is a parallel-member link.

6. The stand according to claim 1, wherein the first arm (104) is a parallel-member link; and
wherein the second arm (106) is a parallel-member link.

7. The stand according to claim 1, further comprising a carrier element (102) configured to pivotably support the first arm (104).

8. The stand according to claim 1, further comprising a mounting device (110) configured to secure a medical device on the second arm (106).

9. The stand according to claim 1, wherein the stand is configured to carry an optical observation device

10. The stand according to claim 1, wherein the stand is configured to carry a surgical microscope.
